(19) United States
(12) Patent Application Publication
(10) Pub. No.: US 2012/0097253 A1
(43) Pub. Date: Apr. 26, 2012

(54) THERMOSTAT-CONTROLLED AUTOMATIC WATER VALVE SYSTEMS

(76) Inventor: Devin Eutsler, Yuba City, CA (US)

(21) Appl. No.: 13/004,887

(22) Filed: Jan. 12, 2011

Related U.S. Application Data
(60) Provisional application No. 61/297,304, filed on Jan. 22, 2010.

(51) Int. Cl. F16K 17/36

(52) U.S. Cl. 137/1; 137/79

(57) ABSTRACT

A thermostat-controlled automatic water valve can be used to turn water from a faucet/spigot on or off automatically based on a preset air temperature. The device is compact, easy to threadingly install and can be used to reliably satisfy the watering or cooling needs of livestock or growing plants. It can also be connected to a cooling mist system enabling it to automatically turn on if the thermostat/temperature controller senses a certain set activation temperature. Building owners can also employ this item to automatically run water to keep pipes from freezing or other similar tasks/events. The device measures ambient temperature and is programmable.

### CROSS-REFERENCE TO RELATED APPLICATION

The present application is related to and claims priority from prior provisional application Ser. Nos. 61/297,304, filed Jan. 22, 2010 and 61/297,304 filed Aug. 22, 2010 which applications are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of valving and more specifically relates to thermostat-controlled automatic water valve systems.

### 2. DESCRIPTION OF THE RELATED ART

Modernly many individuals have access to ‘running water’, available via natural or man-made pressurized systems. Watering systems may be used for a wide array of purposes such as for supplying potable water to humans and livestock for drinking, for cooling livestock or domestic animals on a hot day, and for watering crops, trees and/or gardens. Valving may be used to control the flow of water or lack thereof. These valves may be automatically or manually controlled/manipulated to dispense the desired amount of liquid. Many of these automatic valving means may be manually ‘set’ or alternately flow-response may operate based on a ‘sensed’ condition such as a float being opened when an animal takes a drink or when the level of water gets too low.

Water valves may be left on a slow drip outdoors to prevent pipes from freezing in cold conditions. Frozen pipes may burst under the pressurized expansion of a liquid creating an unnecessary, expensive and time-consuming repair. If left on a constant drip a large quantity of water may be wasted and/or icy conditions may be created near the faucet creating a potential hazard. During warm weather, standard automated systems may be pre-programmed to turn on at a specific time(s) and turn off after a set amount of time passes. This particular solution may be inefficient and waste water on days where the cooler temperature requires only limited watering occur, as animals and plants are not as ‘thirsty’, or in need of cooling. In current systems in order to prevent a costly waste of water, the user typically has to manually gauge the temperature and ‘forecast’ for the day to determine whether or not they activate the automated system. In certain cases, during warmer or windy conditions, animals may become thirsty when owners are not available to dispense more liquid. A more convenient method is needed that enables users to set their watering systems according to ambient temperature(s).

Various attempts have been made to solve the above-mentioned problems such as those found in U.S. Pat. Nos. 7,779,787; 4,771,736; 5,813,363; 2004/0221817; 6,259,955; 5,402,815; 6,125,873; 4,657,038; and 4,176,786. This prior art is representative of valving. None of the above inventions and patents, taken either singly or in combination, is seen to describe the invention as claimed.

Ideally, a thermostat-controlled automatic water valve system should require minimal maintenance and, yet would operate reliably and be manufactured at a modest expense. Thus, a need exists for a reliable, compact thermostat-controlled automatic water valve system to be readily installable on an existing water delivery system and to avoid the above-mentioned problems.

### BRIEF SUMMARY OF THE INVENTION

In view of the foregoing disadvantages inherent in the known valving art, the present invention provides a novel thermostat-controlled automatic water valve system. The general purpose of the present invention, which will be described subsequently in greater detail is to provide a reliable water dispensing means based on ambient temperature(s).

An ambient temperature-sensing flow control system threadingly connectable to a water supply source (potable or other) is disclosed herein comprising: an ambient temperature-sensing flow (control) device having an electromechanical solenoid controlled automatic water valve usable to potably water at least one animate being (or inanimate being such as plants) and/or manipulate a misting system when ambient temperature reaches a pre-determined threshold value pre-set by an individual. The device may also include a temperature sensor in alternate embodiments for sensing the ambient temperature. A digital thermostat/temperature controller comprised by the present invention may be secured in a weather-resistant housing to protect it from environmental damage that may occur from sunlight, moisture, dust and other debris.

The device typically uses at least one DC or AC powerer to power the ambient temperature-sensing flow control system. The powerer provides power allowing the thermostatically controlled automatic water valve system to be repeatably manipulated between on and off control positions. In certain embodiments two threaded coupling members integral with the unit make the device attachable in series (directly or indirectly) to a threaded faucet/spigot or alternately to a hose having a proximate and a distal end, this combination being suitable for remote use. In this way the thermostatically controlled automatic water valve system is remotely attachable to the distal end of the hose connected in series to the water supply source via the threaded spigot. The thermostatically controlled automatic water valve system is threadingly couplable to the water supply source and/or hose preferably via two threaded coupling members (located on opposing sides) to control at least one liquid flow of the water supply source based on the ambient temperature.

Ambient temperature-sensing flow control system also may comprise a touch screen display with a screen portion and plurality of push button imputers whereby a user-inputter may program the device for an in-use condition. Included may also be an electromechanical solenoid for controlling a pressure differential within the valve portion of the thermostatically controlled automatic water valve system, which in turn controls whether the valve is open or closed. The digital or mechanical thermostat/temperature controller and electromechanical solenoid controlled automatic water valve may be mounted together to form a single unit in certain embodiments and may be separate in other versions of the present invention.

The ambient temperature-sensing flow control device is also connectable to the water supply source to provide at least one liquid flow of the water supply to prevent at least one freezing rupture when the ambient temperature reaches a pre-determined threshold value (to effectively prevent freezing of spigots and pipes or to enable watering of trees to prevent freezing/frost) during cold weather conditions. The ambient temperature-sensing flow control device further comprises a through-flow fluid channel wherein the water source is in fluid communication with a hose or other water/fluid transfer means. As mentioned, the thermostatically controlled automatic water valve is controllable via pre-programming by a user manually inputting/changing programming data using buttons or other by other non-manual inputting means.

The thermostat/temperature controller included within the device senses and measures the ambient temperature and determines whether or not the conditions in which the electromechanical solenoid controlled water valve should be set to an on condition exist. When the conditions do exist the thermostat/temperature controller then sets the valve to an on condition.

A method of use for an ambient temperature-sensing flow control system is also discussed herein comprising the steps of: threading connecting an ambient temperature-sensing flow control device having an electromechanical solenoid controlled automatic water valve to a potable (or non-potable) water source; next programming in a ‘set’ temperature in which the ambient temperature-sensing flow control device is activated/deactivated at; and watering at least one being (human, animal, plant or other) with potable (non-potable) water from the potable or non-potable water source. The method of use connecting step may include threadingly connecting either between a spigot and a water transfer hose or to a distal end of the water transfer hose wherein the device may be remotely used. The device may also be used with a manifold for use with hydroponic growing systems or for feedlots or other.

The present invention holds significant improvements and serves as a thermostat-controlled automatic water valve system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, thermostat-controlled automatic water valve system, constructed and operative according to the teachings of the present invention.

FIG. 1 shows a perspective view illustrating a thermostat-controlled automatic water valve system for attachment to a pressurized water supply to provide a thermostat-controlled automatic water valve system according to an embodiment of the present invention.

FIG. 2 is a side perspective view illustrating the thermostat-controlled automatic water valve system according to an embodiment of the present invention of FIG. 1.

FIG. 3 is a front perspective view illustrating the thermostat-controlled automatic water valve system according to an embodiment of the present invention of FIG. 1.

FIG. 4 is a perspective view illustrating thermostat-controlled automatic water valve system in an in-use condition according to an embodiment of the present invention of FIG. 1.

FIG. 5 is a schematic illustrating a control/display means for the thermostat-controlled automatic water valve system according to an embodiment of the present invention of FIG. 1.

FIG. 6 is another schematic for use in enabling the thermostat-controlled automatic water valve system according to an embodiment of the present invention of FIG. 1.

FIG. 7 is yet another schematic for use in enabling the thermostat-controlled automatic water valve system according to an embodiment of the present invention of FIG. 1.

FIG. 8 is a flowchart illustrating a method of use for the thermostat-controlled automatic water valve system according to an embodiment of the present invention of FIGS. 1-7.

The various embodiments of the present invention will hereinafter be described in conjunction with the appended drawings, wherein like designations denote like elements.

### DETAILED DESCRIPTION

As discussed above, embodiments of the present invention relate to a valving device and more particularly to a thermostat-controlled automatic water valve system as used to improve the reliable watering of animals and/or plants based on environmental temperature(s) and conditions. Various embodiments are disclosed herein to provide a solution to the above-mentioned problems and short-comings of the present devices and methods.

Generally, a thermostat-controlled automatic water valve, as disclosed below, can be used to turn flow from a water faucet/spigot on or off automatically based on a preset air temperature. The device is compact, easy to threadingly install (between a spigot and a hose or to the end of a hose for remote use) and can be used to reliably satisfy the watering needs of livestock or growing plants. It can alternately be connected to a cooling mist system enabling it to automatically turn to an on condition if the thermostat/temperature controller senses a certain set temperature. Building owners can also employ this item to automatically run water to keep pipes from freezing during cold conditions. The device measures ambient temperature (indoor or outdoor) and is programmable.

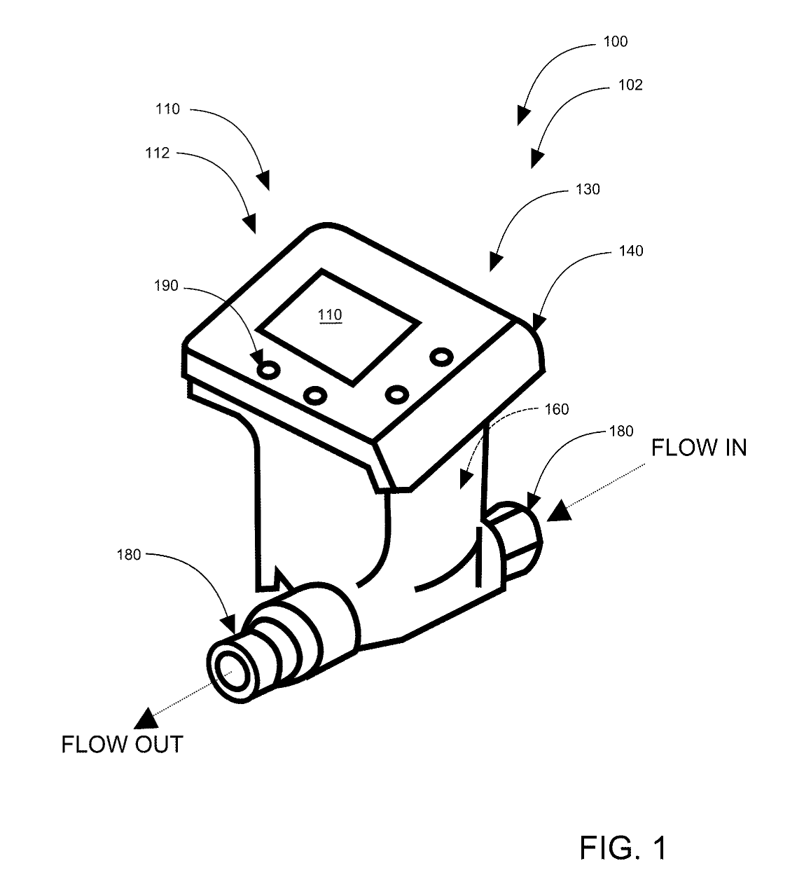

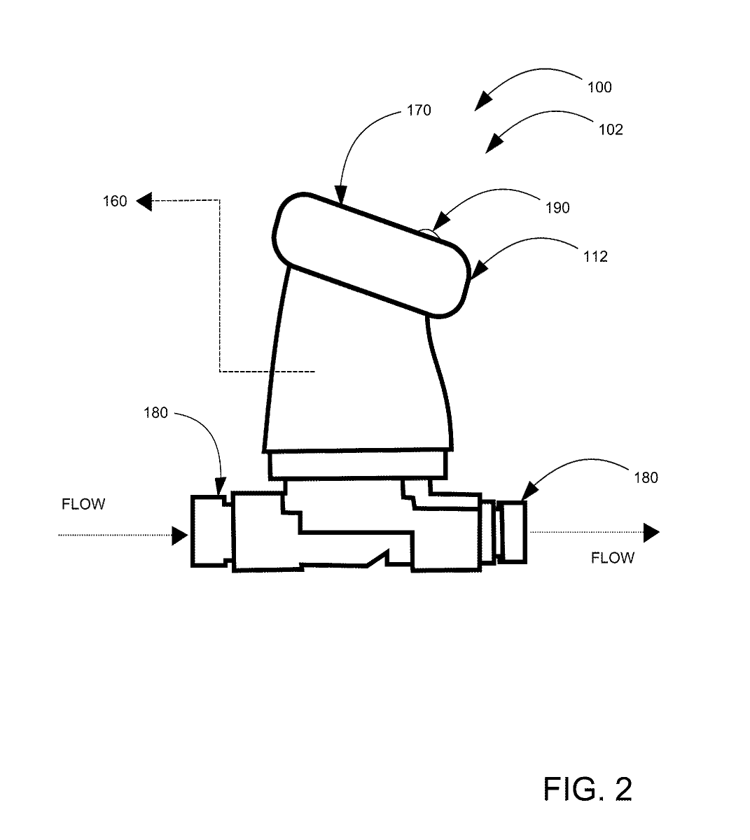

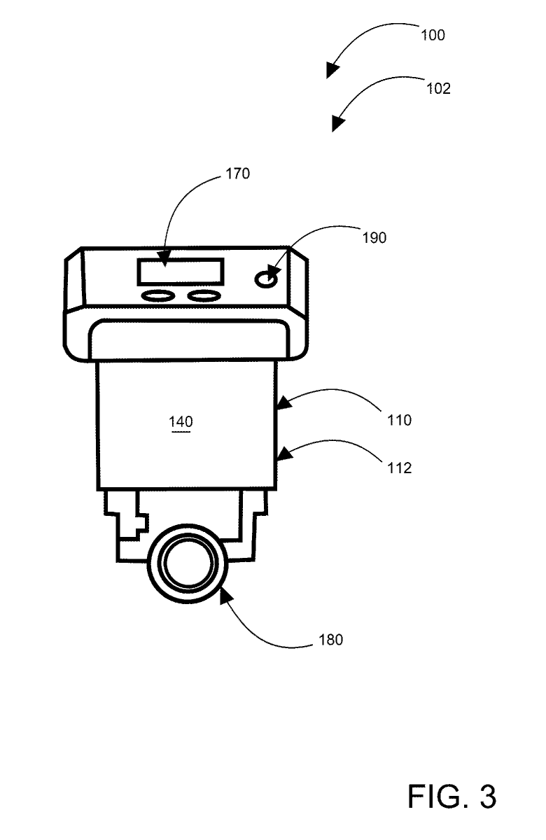

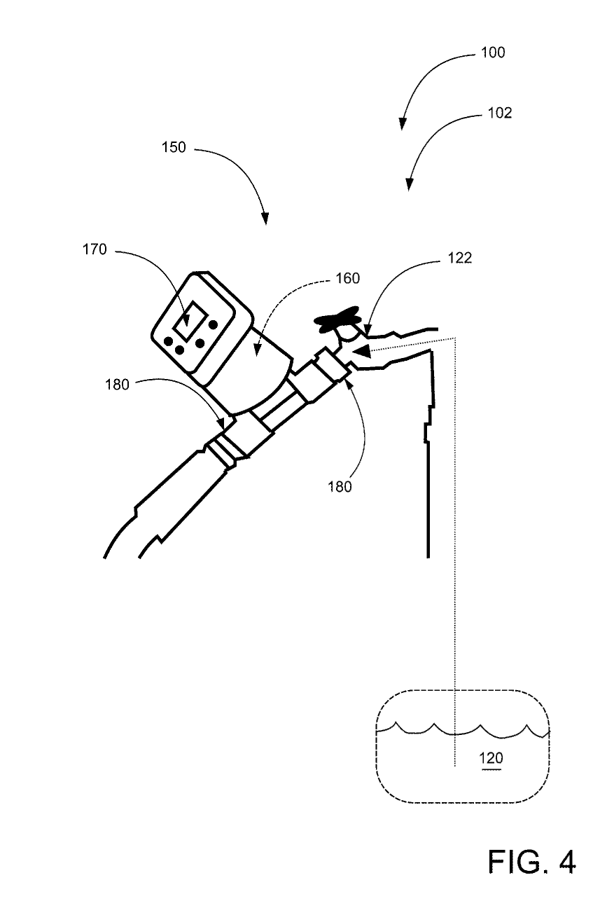

Referring now to the drawings by numerals of reference there is shown in FIGS. 1-4, various perspective views illustrating thermostat-controlled automatic water valve 110 for attachment to a pressurized water supply 120 to provide a thermostat-controlled automatic water valve system 100 according to an embodiment of the present invention. FIG. 4 more specifically is a perspective view illustrating thermostat-controlled automatic water valve system 100 in an in-use condition 150 according to an embodiment of the present invention of FIGS. 1-3.

Referring now to the aforementioned figures, thermostat-controlled automatic water valve system 100 comprises ambient temperature-sensing flow control system 102 according to an embodiment of the present invention which preferably comprises: ambient temperature-sensing flow device 112 having a (thermostatically) thermostat-controlled automatic water valve 110; at least one thermostat/temperature controller 130 secured in weather-resistant housing 140, as a sealed protection means against environmental conditions. In this way the present invention is effectively protected from sunlight, moisture, dust and debris from harming internal components. Weather-resistant housing 140 substantially ensures reliability, and longevity of thermostat-controlled automatic water valve system 110 (ambient temperature-sensing flow control device 112).

In certain embodiments the present invention comprises at least one powerer 160; (powering means) using either DC power (batteries, rechargeable batteries or other) or alternately an AC power adapter in other embodiments. Certain embodiments may have both AC and DC options. An electromechanical solenoid may be used for controlling an automatic water valve 110; wherein powerer 160 provides sufficient and reliable power transferring means allowing thermostatic-controlled automatic water valve system 110 to be repeatably manipulated between on and off positions (various states of open positions and closed).

Thermostat/temperature controller 130 (mechanical or digital type/version may be used) within the present invention to sense and measure ambient temperatures and activates/deactivates an electromechanical solenoid controlled automatic water valve 110. Those with ordinary skill in the art will now appreciate that upon reading this specification and by their understanding the art of thermostats/temperature controllers 130 as described herein, methods of temperature sensing means will be understood by those knowledgeable in such art. It should be appreciated that equivalent temperature sensing means may be substituted and still be considered to be within the scope of this disclosure. Certain embodiments may comprise at least one temperature sensor such as a LM34 Precision Fahrenheit Temperature Sensor as produced by National Semiconductor.

Thermostatic-controlled automatic water valve system 100, as shown in FIG. 4, is threadingly (removably) couplable to at least one water supply source 122 to control at least one liquid/fluid flow of water supply 120 from water supply source 122 via spigot, faucet or other based on ambient temperature. Water supply source 122 comprises pressurized water supply 120 as supplied from a well or water transfer/delivery system and may be pressurized by at least one pump. In this way the present invention is able to completely restrict, limit or provide water for animals and/or plants according to the ambient temperature. For example on warmer days more water may be consumed by animals and/or plants and the present invention may automatically compensate for this by increasing volumes as temperature increases or by operating in an on-condition for a longer duration. As described herein, ambient temperature-sensing flow system 100 comprising ambient temperature-sensing flow device 112 is usable to water at least one animate being when ambient temperature reaches a pre-determined threshold value.

Water supply source 122 comprises potable water such that animals may be sufficiently watered to prevent dehydration. Water supply source 122 via ambient temperature-sensing flow device 112 may be in fluid communication with a watering bowl, tank, manifold or other suitable container or transfer means to which an animal may drink from or plants may be watered by. In certain embodiments such as for use with watering plants water supply source 122 may comprise non-potable water.

Another use for ambient temperature-sensing flow system 102 the inventor has discovered is using ambient temperature-sensing flow device 112 by connecting (hereby embodying connectable) to a misting system to manipulate the misting system according to the sensed ambient temperature. In this way the present invention may be used to provide comfort and relief for humans or animals (caged or otherwise) during/from hot conditions. Upon reading this specification, it should be appreciated that, under appropriate circumstances, considering such issues as user preferences, design preference, structural requirements, marketing preferences, cost, available materials, technological advances, etc., other heat relieving, water/fluid providing functions may be performed via the present invention and still be considered to be within the scope of this disclosure.

Another such example of use for ambient temperature-sensing flow system 102 may include ambient temperature-sensing flow device 112 being connected to water supply source 122 to provide at least one liquid flow of water supply 120 to effectively prevent at least one freezing rupture when the ambient temperature reaches (drops to) a pre-determined threshold value. In this way the invention may be used to prevent direct and indirect damage to water supply source 122 such as ruptured pipes, flooding and other such negative results. Other uses may included watering fruit trees or other such vegetation during cold weather to prevent freezing/frost of the trees/fruit. These happenings may be terms generally as events.

In certain embodiments thermostat/temperature controller 130 and electromechanical solenoid controlled automatic water valve 110 may be mounted together to form a single unit (assembly) or in other embodiments thermostat/temperature controller 130 and electromechanical solenoid controlled automatic water valve 110 may be mounted separately. Another perceived benefit and novelty of thermostatic-controlled automatic water valve system 100 is that it is remotely attachable to a hose end (on a distal or proximate end of the hose) connected to water supply source 122. In this way thermostatic-controlled automatic water valve 110 may be connected in series between water supply source 122 and a hose (as shown in FIG. 4) or at the end of the hose for remote use. Additionally, considering this relationship thermostatic-controlled automatic water valve 110 may comprise a controlling and a transferring means for water supply source 122 while delivering water supply 120. Thermostatic-controlled automatic water valve system 100 is preferably controlled via pre-programming by at least one user such as a pet owner, a gardener, a farmer or other such user-manipulator.

In FIGS. 1-4 ambient temperature-sensing flow system 102 preferably comprises two threaded coupling members 180, preferably one located on each side of ambient temperature-sensing flow device 112 such that thermostat-controlled automatic water valve 110 may be removably coupled to a faucet, spigot and/or a hose. Ambient temperature-sensing flow device 112 comprises a through-flow fluid channel wherein water may be communicated there through providing a suitable internal fluid transfer means for example when used in a series relationship between water supply source 122 and a hose or other final water destination container.

Ambient temperature-sensing flow system 102 is a control system which may comprise touch screen 170 on ambient temperature-sensing flow device 112 providing a user-friendly visual means for use when programming, inputting and outputting data. Ambient temperature-sensing flow system 102 may further comprise at least one pushbutton imputer (button 190).

Referring generally now to controls as preferably used with ambient temperature-sensing flow system 102, button 190 may comprise Manual Up, Down, and Menu pushable buttons 190 (it should be appreciated that more/less buttons 190 or alternate means of input may also be used). Manual/Up button 190 may be used to adjust the activation temperature up when the controller is on the adjustment screens. When the controller is in manual mode, button 190 may be used to turn thermostat-controlled automatic water valve 110 on and off.

Down button 190 may be used to adjust the activation temperature down when the controller is on the adjustment screens. Menu button 190 may be used to scroll through the various mode and setup screens.

Referring now to screens/modes on the controller of the present prototype, “AUTO MODE”—while on this screen, ambient temperature-sensing flow device 112 preferably provides both cooling and heating. It should be appreciated that a user may select the set temperatures according to application and preference. “MANUAL MODE”—while the controller is on this screen, the unit can be turned on and off by pressing the button labeled “MANUAL”. The unit will not activate automatically based on temperature while on this screen. “ALL OFF”—While the controller is on this screen, the unit will do nothing but display the current ambient temperature. “COOL MODE”—While the controller is on this screen, the unit's activation temperature for cool mode can be adjusted up or down using alternately colored up or down arrows on the face of the controller. While the controller is left on this screen, the unit will operate in automatic “COOL MODE” only.

How “COOL MODE” works: Assuming the user is using water to provide a cooling effect, when the ambient temperature rises above the selected activation temperature, thermostat-controlled automatic water valve system 100 will automatically turn on.

“HEAT MODE”—While the controller is on this screen, the unit's activation temperature for heat mode can be adjusted up or down using the alternately colored up or down arrows on the face of the controller. While the controller is left on this screen, the unit will operate in automatic “HEAT MODE” only.

How “HEAT MODE” works: Assuming the user is using water to provide a heating or warming effect, when the ambient temperature falls below the selected activation temperature, thermostat-controlled automatic water valve system 100 will automatically turn on. In these ways the present invention may be suitably controlled and programmed.

Referring generally now to a first preferred embodiment of the present invention, thermostat-controlled automatic water valve system 100 can be used to turn (manipulate) a water faucet between ‘on’ or ‘off’ automatically based on a preset air temperature. Thermostat-controlled automatic water valve system 100 is relatively compact in size, easy to install and can be used to satisfy the watering needs of livestock and/or growing plants (hydroponically or naturally). The device may be connected to a cooling mist system enabling it to automatically turn on if thermostat/temperature controller 130 senses a certain temperature. Building owners can also employ this item to automatically run water to keep pipes from freezing or other similar tasks. This item is ideal for consumers looking for a temperature activated automated watering system.

Thermostat-controlled automatic water valve system 100, as mentioned previously, can be easily installed on an existing water valve (water supply source 122—spigot or faucet—indoor or outdoor) thereby enabling it to be manipulated between on and off positions once a specified ambient temperature is reached.

In other embodiments thermostat-controlled automatic water valve 110 may be integrated into the existing (OEM) portable timers that attach to a garden hose or hose bib. In the case of the electronic versions that exist, most of the componentry and the way the valve is activated is exactly the same with the exception of the temperature sensing ability. The addition of a temp sensor and some adjustments to the programming of the timer is all that is necessary to make it operate in the same manner as thermostat-controlled automatic water valve system 100. In this way the present invention may be used (retro-fitted) with an OEM system or as a stand-alone unit.

Thermostat-controlled automatic water valve system 100 may be manufactured and provided for sale in a wide variety of sizes and shapes for a wide assortment of applications. Thermostat-controlled automatic water valve system 100 can be packaged as a kit with threaded adapter fittings, including but not limited to, allowing the device to be attached to a standard hose bib and garden hose. The kit may comprise a set of user instructions for use in programming and other. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, AC and/or DC powerers/adapted customized parts, different screens/push button arrangements, parts may be sold separately, etc., may be sufficient.

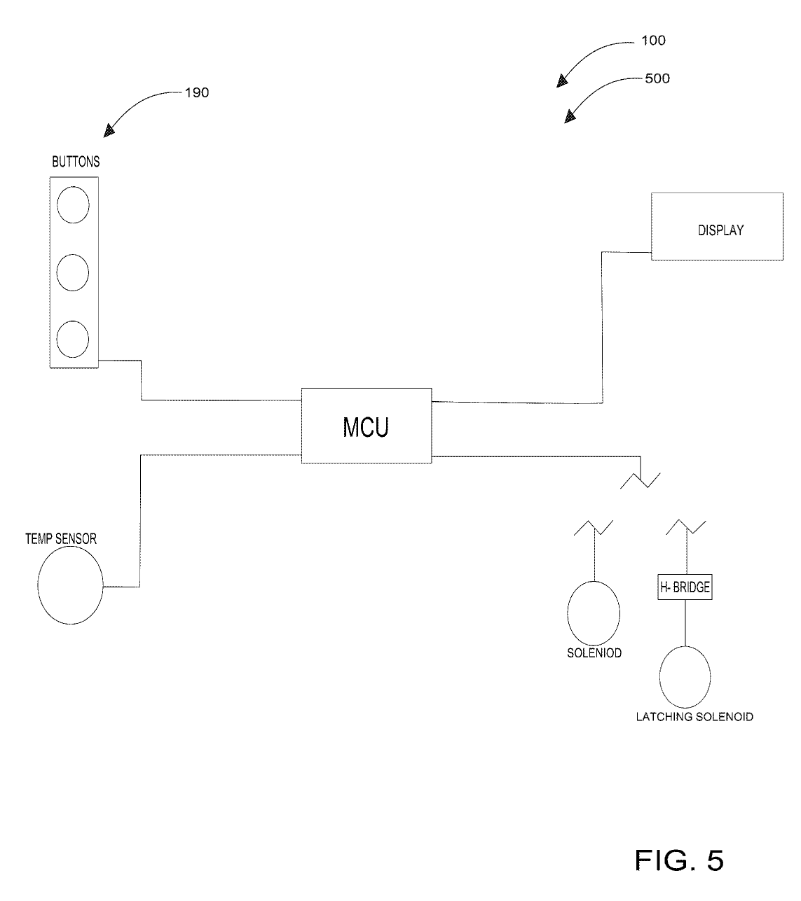

Referring now to FIG. 5, a schematic 500 illustrating a control/display means for thermostat-controlled automatic water valve system 100 according to an embodiment of the present invention of FIG. 1.

Schematic 500 is provided for enabling electronic version of thermostat controlled automatic water valve system 100. While typical electronic devices are comprised of a great deal of various components such as resistors, transistors, diodes and other such components, this document will describe the basic components of thermostat controlled automatic water valve system 100, and their role in the function of the present invention. As shown in schematic 500 there are five key components. They are a micro control unit (MCU), button(s) 190 for input, a temperature sensor, a display and an electromechanical solenoid which actuates a water valve. The MCU, buttons, temperature sensor and display combined form the thermostat/temperature controller that controls the integrated electromechanical solenoid controlled automatic water valve.

The MCU comprises the “brains” of the device. It links all of the various components together and executes the programming for thermostat controlled automatic water valve system 100. The MCU preferably uses the temperature sensor to monitor the ambient air temperature.

Buttons 190 provide a means of input for the user. Buttons 190 allow the user to change the activation temperatures, modes and menus of the device. Upon reading this specification, it should be appreciated that, under appropriate circumstances, considering such issues as user preferences, design preference, structural requirements, marketing preferences, cost, available materials, technological advances, etc., other inputting arrangements and means such as, for example, touch screen 170, other forms of buttons, switches, etc., may be sufficient.

The display is the means whereby a user accesses information necessary for the proper use of the device. This information may comprise current ambient temperature, what mode the device is currently operating in and the activation temperatures the device is set to use.

The solenoid is the MCU's means for controlling water flow in the thermostat-controlled automatic water valve system 110. The position of the armature in the solenoid is controlled by an application of voltage, which is controlled by the MCU. The position of the armature determines whether automatic water valve 110 is open or closed. There are at least two different types of solenoids that can be implemented in the construction of ambient temperature-sensing flow control system 102. The first option, 1) Standard Solenoid: When voltage is applied to the terminals of the solenoid the armature moves to a position that allows automatic water valve 110 to open and allow water there through. Voltage must be applied to the terminals the entire time thermostat-controlled automatic water valve 110 is to be in an on condition. Advantages to using a standard solenoid is that it is simple to set up and apply voltage to through the use of a simple relay making it very reliable in-use. The disadvantages to using a standard solenoid is the voltage must be applied the entire time thermostat-controlled automatic water valve 110 is to be on, therefore it is not very energy efficient. The time that thermostat-controlled automatic water valve 110 may need to be in an on condition is potentially very lengthy if the ambient temperature dictates that the device be in an on condition for a lengthy period of time. Accordingly, this would mean thermostat-controlled automatic water valve 110 would preferably use a power source such as a wall adapter, (powerer 160) instead of using DC battery power, therefore diminishing the portability of the device, however increasing its reliability in service.

An alternate option using a 2) Latching Solenoid: When a pulse of voltage is applied to the terminals of the solenoid, the armature moves to one position, where it will stay. To change the position of the armature in the solenoid, the polarity of the pulse of voltage to the terminals of the solenoid is reversed. For example, to turn thermostat-controlled automatic water valve system 100 on, terminal one would receive positive voltage and terminal two would receive ground. To turn thermostat-controlled automatic water valve 110 off, terminal one would receive ground and terminal two would receive positive voltage. The reversing of polarity to the terminals of the solenoid can be accomplished through the use of an H-bridge structure, or via at least one relay(s). Either of these components would be controlled by the MCU. The advantages to a latching solenoid is that it is suitably more energy efficient than a standard solenoid, allowing the device to be battery powered (using DC version of powerer 160). This permits ambient temperature-sensing flow control device 112 to be portable in nature. The disadvantages to a latching solenoid is they are much more sensitive than a standard solenoid. Therefore, they may not prove as reliable as a standard solenoid. These versions are not as readily available and replaceable and are typically considerably more complicated to set up and operate than a standard solenoid. The manufacturer or user may use either version depending on the desired application.

Referring now generally to how thermostat-controlled automatic water valve system 100 works within the embodiment(s) described.

Thermostat-controlled automatic water valve 110 behaves in much the same way(s) as a conventional thermostat for a household HVAC system having a “cool” mode and a “heat” mode. “Cool mode” being that if the ambient temperature rises above the user set activation temperature, then the controller will automatically activate the water valve. “Heat mode” being that if the ambient temperature falls below the user set activation temperature, then the controller will automatically activate the water valve. The user can adjust the activation temperatures with the use of (integrated) buttons 190 and/or switches (in certain embodiments using touch screen 170). MCU such as those manufactured by ATMEL may be used (8-bit AVR Microcontroller). When the MCU determines that the conditions are met for thermostat-controlled automatic water valve 110 (interchangeably also referred to as ambient temperature-sensing flow device 112 within this document) to be turned on/opened, it does so by either, in the case of a standard solenoid, sending voltage through one of its pins to the coil of a relay, which in turn closes the contacts of the relay to allow a greater voltage and current than the MCU itself could handle to go to the terminals of the solenoid, thus moving the armature in the solenoid and turning thermostat-controlled automatic water valve 110 on.

To turn thermostat-controlled automatic water valve 110 off, the MCU simply ceases to send voltage to the relay. To turn thermostat-controlled automatic water valve 110 on in the case of a latching solenoid, the MCU sends a pulse of voltage through one of its pins to a control channel of an H-bridge structure, channel one for example. The H-bridge then outputs a pulse of positive voltage to one terminal, terminal one for instance, and ground to the other terminal, terminal two of the solenoid, which causes the armature to move to the position that allows the water valve to open. To turn thermostat-controlled automatic water valve 110 off the MCU sends a pulse of voltage out of another pin to another channel of the H-bridge, channel two for example. The H-bridge then sends out a pulse of positive voltage and ground to the terminals in reverse of what it did to turn thermostat-controlled automatic water valve 110 on. This moves the armature to the opposite position, thus turning thermostat-controlled automatic water valve 110 off, as shown in the present FIG. 5. Latching solenoid valves such as those made by General Imsubs (found at http://giplindia.com/latching-solenoid-valve.htm) may be used. Standard solenoid valves as made by Hunter® at (http://www.hunterindustries.com/Resources/PDFs/Brochures/Domestic/lit176w.pdf) may be used (as in the working prototype with an available latching solenoid).

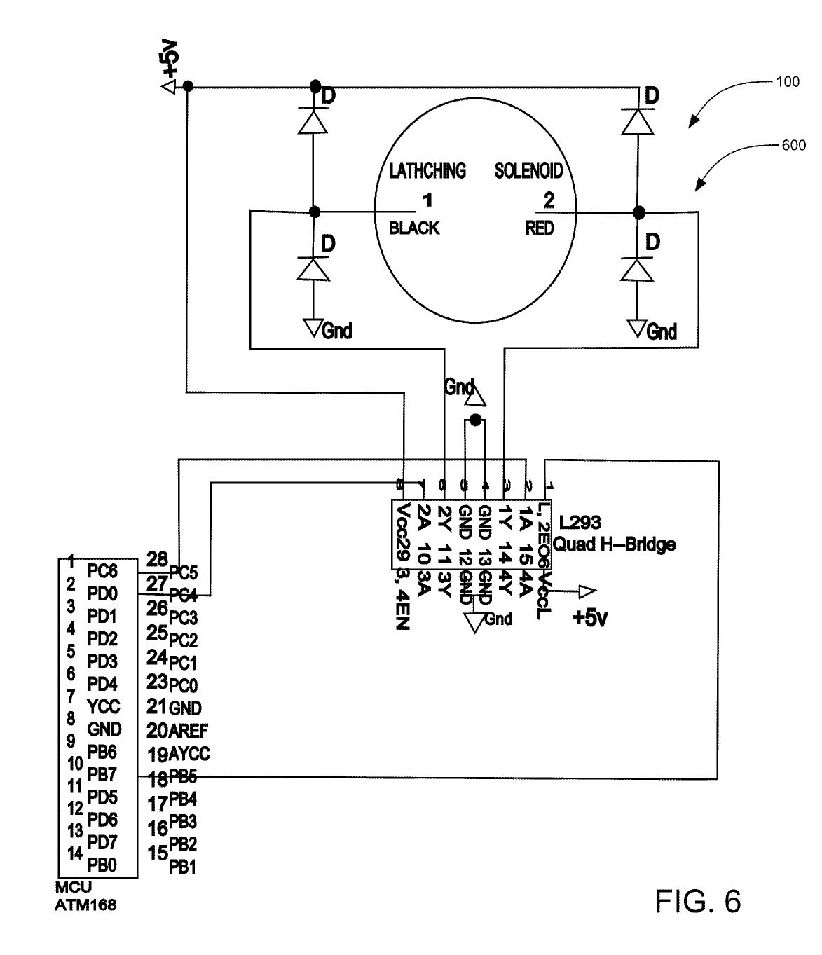

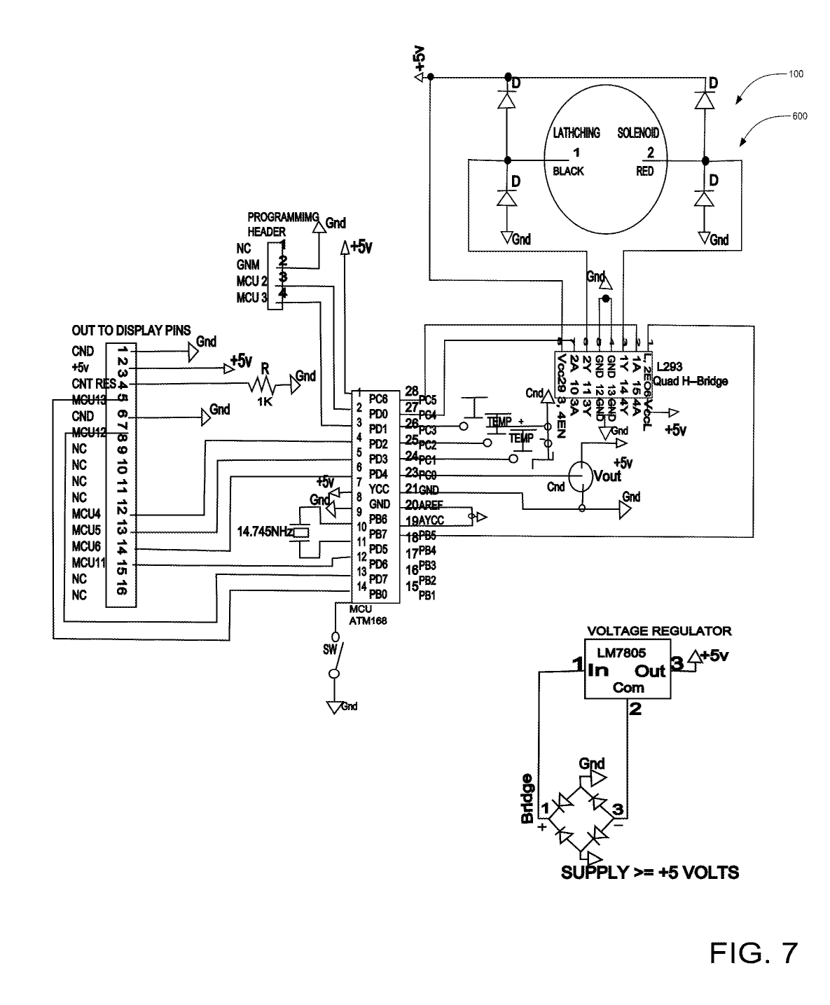

Referring now to FIGS. 6-7, schematics 600 and 700 (respectively) for use in enabling thermostat-controlled automatic water valve system 100 according to at least one embodiment of the present invention of FIGS. 1-5.

Referring first to FIG. 6 showing schematic 600 demonstrating a method for wiring an L293 H-Bridge for use in thermostat-controlled automatic water valve 110. Those with ordinary skill in the art will now appreciate that upon reading this specification and by their understanding the art of L293 H-Bridges as described herein, methods of wiring will be understood by those knowledgeable in such art as based on schematic 600. It should be noted that the L293 H Bridge structure is one example of an integrated circuit that could be implemented in the construction of the thermostat controlled automatic water valve. It should be appreciated that there are other available options. Furthermore, a suitable H Bridge structure could be constructed using discrete components such as transistors and rectifiers as appreciated by those knowledgeable in electronic engineering. The reversing of polarity to the terminals of the latching solenoid can also be accomplished using relays (at least one) controlled by the MCU.

Referring now to FIG. 7, schematic 700 more specifically a schematic for building a working prototype of thermostat-controlled automatic water valve 110. It should be appreciated that the schematic is one method of enabling the present invention and that other suitable equivalents may be substituted or altered and will still be considered to be within the scope of the present invention.

The following program is provided for enabling a working prototype, (written in C code and complimenting the included wiring schematic) of thermostat-controlled automatic water valve 110 for use in thermostat-controlled automatic water valve system 100.

It should be noted that libnerdkits can be credited for three lines of code within the above program bearing their name, and that the inventor intends to use them only as an enabling means whereby the present invention may be duplicated, however it should be appreciated that the referenced text may be substituted with equivalent programming.

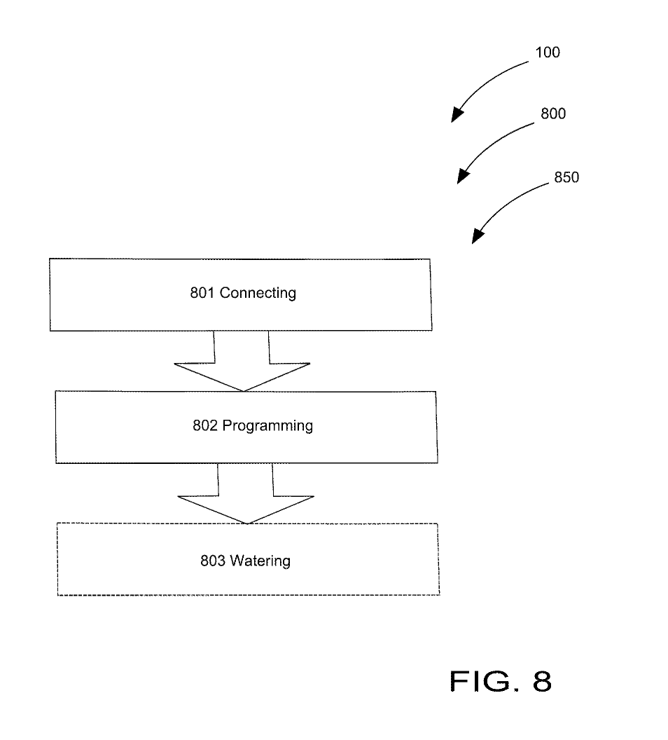

Referring now to FIG. 8, a flowchart 850 illustrating a method of use 800 for thermostat-controlled automatic water valve system 100 according to an embodiment of the present invention of FIGS. 1-7

A method of use 800 for ambient temperature-sensing flow system 102 (thermostat-controlled automatic water valve system 100) preferably comprises the steps of: step one 801 threadingly connecting ambient temperature-sensing flow device 112 (control device) having an electromechanical solenoid controlled automatic water valve 110 to a potable water source (water supply source 122); step two 802 programming in a set temperature in which ambient temperature-sensing flow device 112 is activated at; and step three 803 watering at least one being with potable water from potable water source (water supply source 122).

Ambient temperature-sensing flow device 102 is threadingly connected (connectable) either between a spigot and a water transfer hose or to a distal end of the water transfer hose, as discussed above.

Set up of ambient temperature-sensing flow system 102 may comprise: 1) attaching female inlet side (threaded coupling members 180) of ambient temperature-sensing flow device 112 to the male threads of a standard hose bib and attaching a hose to the male outlet side (threaded coupling members 180) of ambient temperature-sensing flow device 112, making sure that all connections are secure and the display on ambient temperature-sensing flow device 112 is upright and easily viewable; next turning the water on (water supply 120) and making sure there are no leaks; 2) plugging the included power adapter (powerer 160) into a 110 v power source, then plugging the male plug from the power adapter (powerer 160) into the female port on the side of the device; (install battery in battery powered version) and 3) at this juncture a user can access the various menu screens using the buttons 190 on the front of ambient temperature-sensing flow system 102 to set up and use thermostat-controlled automatic water valve system 100.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An ambient temperature-sensing flow system comprising:
an ambient temperature-sensing flow device having an electromechanical solenoid controlled automatic water valve;
at least one thermostat/temperature controller secured in a weather-resistant housing;
at least one powerer;
at least one electromechanical solenoid coil for controlling water flow through said automatic water valve;
wherein said at least one powerer provides power allowing said thermostatically controlled automatic water valve system to be repeatedly manipulated between on and off positions;
wherein said thermostat/temperature controller senses and measures said ambient temperatures and controls said electromechanical solenoid controlled automatic water valve; and
wherein said thermostatically controlled automatic water valve system is threadingly couplable to a water supply source to control at least one liquid flow from said water supply source based on said ambient temperature.

2. The ambient temperature-sensing flow system of claim 1 wherein said ambient temperature-sensing flow device is usable to water at least one animate being when said ambient temperature reaches a pre-determined threshold value.

3. The ambient temperature-sensing flow system of claim 1 further comprising a temperature sensor.

4. The ambient temperature-sensing flow system of claim 2 wherein said water supply source comprises potable water.

5. The ambient temperature-sensing flow system of claim 1 wherein said ambient temperature-sensing flow device is connectable to a misting system to manipulate said misting system according to said ambient temperature.

6. The ambient temperature-sensing flow system of claim 1 wherein said ambient temperature-sensing flow device is connectable to said water supply source to provide at least one said liquid flow of said water supply to prevent at least one freezing event when said ambient temperature reaches a pre-determined threshold value.

7. The ambient temperature-sensing flow system of claim 1 wherein said at least one powerer comprises DC power.

8. The ambient temperature-sensing flow system of claim 1 wherein said at least one powerer comprises an AC power adapter.

9. The ambient temperature-sensing flow system of claim 1 wherein said electromechanical solenoid controlled automatic water valve is controlled via a mechanical version of said thermostat/temperature controller.

10. The ambient temperature-sensing flow system of claim 1 wherein said electromechanical solenoid controlled automatic water valve is controlled via a digital version of said thermostat/temperature controller.

11. The ambient temperature-sensing flow system of claim 1 wherein said thermostat/temperature controller and said electromechanical solenoid controlled automatic water valve may be mounted together to form a single unit.

12. The ambient temperature-sensing flow system of claim 1 wherein said thermostatically controlled automatic water valve is remotely attachable to a distal hose end connected to said water supply source.

13. The ambient temperature-sensing flow system of claim 1 wherein said thermostatically controlled automatic water valve is controlled via pre-programming.

14. The ambient temperature-sensing flow system of claim 1 further comprising a touch screen.

15. The ambient temperature-sensing flow system of claim 1 wherein said ambient temperature-sensing flow device comprises two threaded coupling members.

16. The ambient temperature-sensing flow system of claim 1 wherein said ambient temperature-sensing flow device comprises a through-flow fluid channel.

17. The ambient temperature-sensing flow system of claim 1 further comprising at least one pushbutton inputter.

18. An ambient temperature-sensing flow control system threadingly connectable to a water supply source comprising:
an ambient temperature-sensing flow control device having a thermostatically controlled automatic water valve usable to potably water at least one animate being and/or manipulate a misting system when ambient temperature reaches a pre-determined threshold value;
a temperature sensor for sensing at least one said ambient temperature;
at least one digital thermostat secured in a weather-resistant housing;
at least one powerer to power said ambient temperature-sensing flow system;
two threaded coupling members attachable in series to a threaded spigot or hose, said hose having a proximate and a distal threaded end;
a touch screen with a screen portion and plurality of push button inputers;
at least one electromechanical solenoid coil for controlling water flow through an automatic water valve;
wherein said at least one powerer provides power allowing said thermostatically controlled automatic water valve to be repeatably manipulated between on and off control positions;
wherein said digital thermostat/temperature controller and said electromechanical solenoid controlled automatic water valve may be mounted together to form a single unit;
wherein said thermostatically controlled automatic water valve is remotely attachable to said distal threaded end of said hose connected in series to said water supply source via said threaded spigot;
wherein said ambient temperature-sensing flow control device is connectable to said water supply source to provide at least one liquid flow of said water supply to prevent at least one freezing rupture when said ambient temperature reaches a said pre-determined threshold value;
wherein said ambient temperature-sensing flow control device comprises a through-flow fluid channel;
wherein said thermostatically controlled automatic water valve is controllable via pre-programming;
wherein said thermostat/temperature controller senses and measures said ambient temperatures and activates/deactivates said thermostatically controlled automatic water valve system; and
wherein said thermostatically controlled automatic water valve is threadingly couplable to said water supply source via said two threaded coupling members to control at least one liquid flow of said water supply source based on said ambient temperature.

19. A method of use for an ambient temperature-sensing flow system comprising the steps of:
threading connecting an ambient temperature-sensing flow device having a electromechanical solenoid controlled automatic water valve to a potable water source;
programming in a set temperature in which said ambient temperature-sensing flow device is activated at; and
watering at least one being with potable water from said potable water source.

20. The method of use for an ambient temperature-sensing flow system wherein said ambient temperature-sensing flow device is threadingly connected either between a spigot and a water transfer hose or to a distal end of said water transfer hose.
